(19) United States
(12) Patent Application Publication
(10) Pub. No.: US 2003/0078794 A1
(43) Pub. Date: Apr. 24, 2003

(54) System and method for facilitating specifier and supplier communications

(76) Inventor: Richard J. Knapp, Hillsborough, NC (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 10/047,717

(22) Filed: Oct. 23, 2001

(51) Int. Cl. G06F 17/60

(52) U.S. Cl. 705/1; 705/8

(57) ABSTRACT

The present disclosure relates to a system and method for facilitating communications between designers and suppliers and, more particularly, to a system and method that allows efficient communications between designers and suppliers related to color requirements and/or capabilities.

### BACKGROUND

1. Technical Field

The present disclosure relates to a system and method for facilitating color-related communications between designers/specifiers and suppliers and, more particularly, to a system and method that allows efficient communications between designers/specifiers and suppliers related to color requirements and/or capabilities.

2. Background Art

Color is a fundamental building block in countless industries and production environments, including the textile, printing and manufacturing industries. Historically, communications between designers/specifiers and color suppliers have involved manual processes that are based in large measure on physical standards and/or samples. For example, in the textile industry, textile specifiers have generally fabricated a desired color standard and shipped the standard to one or more potential suppliers around the world. Upon receipt of the desired color standard, each supplier undertakes to make color match(es), submitting physical exemplars of their “matches” to the designer/specifier for quality control evaluation. Based on the quality control results, the designer/specifier may accept or reject the supplier's submission and/or request revised submission(s) from the supplier. Thus, the color management process has historically been slow, relatively inefficient and dependent on the transmission of physical standards.

In an alternative and/or supplemental approach to the exchange of physical standards, entities involved in color management also communicate with each other using calorimetric measurement values, e.g., CIE-Lab, XYZ, RGB, density, CMYK and/or spectral measurement values, and/or using colors names, e.g., using the Pantone®, RAL, NCS, Toyo or HKS systems. Information concerning such color names, e.g., Pantone®, may be accessed from generally available data sources by entities involved in the color process, e.g., by accessing database information over the Internet. In addition, when device-dependent color spaces are used to communicate in the context of color management, color profiles assigned to those color coordinates are generally used to ensure accurate color communications. Applicable algorithms, procedures and data exchange standards have been defined by the International Color Consortium (the “ICC”) and generally take the form of ICC and/or device profiles.

In an alternatively proposed system for color communication, the “Colorcurve System” is described as combining visual and numeric systems in communications between specifiers or creators of color, and manufacturers of colored products. Thus, according to the Colorcurve System, communications include four elements: (1) aim points in CIE L*a*b* color space; (2) physical representation(s) of aim points; (3) data tables and numeric descriptions of the aim points; and (4) computational methods and/or computer software. The proposed Colorcurve System is described in an article entitled “The Colorcurve System®),” Color Research and Application, Vol. 17, No. 4, August 1992, pgs. 263-72.

Beyond the color communication systems described herein, a universal XML-based language referred to as the “Color Exchange Format” or “CxF” has been developed for use in communicating color information. CxF is a standard that allows seamless, worldwide digital communication of commercially significant aspects of spot colors. CxF is an open source language, permitting software vendors that implement and support CxF to extend basic feature set(s) to the needs of new application(s) without affecting general usability. The CxF language facilitates effective communication by entities involved in color management of numerous color-related attributes, e.g., serial numbers, part numbers, color mixtures, pigment prices, light resistance of the color, descriptions, applications notes, comments and the like.

The patent literature also reveals development efforts in the field of color management and/or color communication. Commonly assigned U.S. Pat. No. 6,043,894 to Van Aken et al. describes a method/system for maintaining uniformity among color measuring instruments that is commercially available as the “NetProfiler” system/service. The Van Aken '894 and NetProfiler systems involve measuring color values of a set of master color standards on a master color measuring instrument at a master color lab, and measuring color values of sets of working color standards on the same instrument to determine calibration values. The working sets are provided to remote location(s) for use on remote color measuring instrument(s), and the working sets are measured on such remote color measuring instrument(s) to obtain color value measurements that are transmitted to the master color lab. The measurements from the remote instrument(s) are compared with the calibration values obtained from measurements on the master instrument to generate profiles that are provided to the remote color lab(s). The profiles are applied to measured color values for the set of working color standards to obtain corrected color values. The measured values are generally transmitted to the master color lab and analyzed to determine compliance with specifications as to permissible deviations over computer networks such as the Internet.

A further system for communicating color information between entities, e.g., a design department and a dyehouse, has been developed by Datacolor International (Charlotte, N.C.) and is commercially available under the name “Colorite.” According to published literature, the Colorite system allows users to calibrate computer monitors to a specified level of precision using a CRT probe to measure the screen and provide data for calibration. The user calibrates the monitor daily using the Colorite software and desired color(s) may be created using conventional methods, such as on-screen graphic tools, color measurement from a physical standard applied to the desired substrate, or numerical values that have been entered. The colors may be simulated under a variety of illuminants that permit examination and adjustment of appearance and metamerism. Once the desired visual effect has been achieved, the color is transmitted using a standard computer transmission methodology, e.g., e-mail, ftp, IRC or ISDN, to another site for sourcing or manufacturing. The Colorite system includes software that allows a designer/specifier and a vendor/supplier to engage in a discussion while viewing identical images at different locations. Archival retention of color information may be undertaken to create digital assets.

Despite development efforts to date, a need exists for a system and method for facilitating communications between designers/specifiers and suppliers and, more particularly, for a system and method allowing efficient communications between designers/specifiers and suppliers related to color requirements and/or capabilities.

### SUMMARY OF THE DISCLOSURE

The present disclosure relates to a system and method for facilitating communications between designers/specifiers and suppliers and, more particularly, to a system and method that allows efficient communications between designers/specifiers and suppliers related to color requirements and/or capabilities. In preferred embodiments according to the present disclosure, a system and method are provided for communicating and managing transfer(s) of color information and/or associated tolerancing specifications to and among a distributed network of users. The disclosed system and method permits: (i) a specifier/designer to create/select colors of his/her choosing, i.e., his/her desired palette; (ii) a specifier/designer to define his/her color supply chain; and (iii) the subsequent business-to-business process by which supplier(s) are validated and/or selected for production of the desired color(s) to be automated and/or tracked.

The disclosed system and method utilize a client-server architecture designed to allow color palettes to be authored, communicated, managed and displayed (i.e., simulated) throughout a network of designers/specifiers and suppliers. The server side of the client-server architecture is provided with programming that manages information exchange between respective client applications. The disclosed system and method facilitates color consistency across a distributed network of facilities, working with color measuring instruments, e.g., spectrophotometers and associated ancillary equipment and software, to determine/establish whether color formulations meet applicable specifications set by designers/specifiers.

According to preferred embodiments of the present disclosure, the designer/specifier client advantageously allows users to: (i) construct color palettes, in the form of electronic palettes or “e-palettes;” (ii) define a desired supplier chain for communicative interaction; (iii) post or communicate e-palette(s) to the server for further transmission to desired supplier(s); and (iv) receive, evaluate and/or respond to responsive communications received from supplier(s) via the server. The supplier client, in turn, generally allows users to: (i) query the server for new entries from designers/specifiers; (ii) download e-palettes made available for transmission to such supplier from the server by a specifier; (iii) formulate and manage responses to specifier(s); and (iv) formulate recipes/check batches for quality control prior to transmitting such information to specifier(s) via the server.

The disclosed system and method preferably utilizes existing spectrophotometer calibration technology, e.g., the NetProfiler™ system/service available from GretagMacbeth (New Windsor, N.Y.), to remove the portion of the error budget otherwise associated with instrument functionality issues and differences. The NetProfiler™ system operates across a computer network, e.g., an intranet and/or the Internet, to unify/calibrate color measurements of all participating spectrophotometers.

In preferred embodiments of the disclosed system/method, the XML-based CxF language is utilized to facilitate digital communications across the server/client architecture between designers/specifiers and suppliers. Thus, the manner and degree to which color is characterized in communications according to the disclosed system/method are enhanced through the additional data/information elements and/or details incorporated in digital transmissions utilizing the CxF standard.

Additional features and functions of the disclosed system and method will be apparent from the detailed description which follows.

### BRIEF DESCRIPTION OF THE FIGURE(S)

So that those of ordinary skill in the art to which the subject matter of the present disclosure appertains will more readily understand how to construct and use the method/system of the present disclosure, reference may be had to the following figures and the accompanying detailed description, wherein:

FIG. 1 is a diagrammatic representation of an exemplary color management and communication system deployment according to the present disclosure;

FIG. 2 is a further diagrammatic representation of an exemplary color management and communication system according to the present disclosure;

FIG. 3 is an additional diagrammatic representation of an exemplary color management and communication system according to the present disclosure;

FIG. 4 is an exemplary screen for use by a designer/specifier in establishing an e-palette according to an embodiment of the present disclosure;

FIG. 5 is a further exemplary screen for use by a designer/specifier in establishing an e-palette according to an embodiment of the present disclosure;

FIG. 6 is an additional exemplary screen for use by a designer/specifier in establishing an e-palette according to an embodiment of the present disclosure;

FIG. 7 is a further exemplary screen for use by a designer/specifier in establishing an e-palette according to an embodiment of the present disclosure;

FIG. 8 is an additional exemplary screen for use by a designer/specifier in establishing an e-palette according to an embodiment of the present disclosure;

FIG. 9 is a further exemplary screen for use by a designer/specifier in establishing an e-palette according to an embodiment of the present disclosure;

FIG. 10 is an exemplary screen for use by a designer/specifier in submitting an e-palette for review by supplier(s) according to an embodiment of the present disclosure;

FIG. 11 is an exemplary screen for use by a supplier in reviewing e-palette submissions by designer(s)/specifier(s) according to an embodiment of the present disclosure;

FIG. 12 is a further exemplary screen for use by a supplier in reviewing e-palette submissions by designer(s)/specifier(s) according to an embodiment of the present disclosure;

FIG. 13 is an exemplary screen for use by a supplier in responding to an e-palette submission made by a designer/specifier according to an embodiment of the present disclosure;

FIG. 14 is a further exemplary screen for use by a supplier in responding to an e-palette submission made by a designer/specifier according to an embodiment of the present disclosure;

FIG. 15 is an exemplary screen for use by a designer/specifier in reviewing submission(s) from supplier(s) in connection with an e-palette according to an embodiment of the present disclosure;

FIG. 16 is a further exemplary screen for use by a designer/specifier in reviewing a submission from a supplier in connection with an e-palette according to an embodiment of the present disclosure; and

FIG. 17 is an exemplary screen for use by a designer/specifier in responding to a submission from a supplier in connection with an e-palette according to an embodiment of the present disclosure.

### DETAILED DESCRIPTION OF PREFERRED EMBODIMENT(S)

As noted above, the present disclosure relates to a system and method for facilitating communications between designers/specifiers and suppliers and, more particularly, to a system and method that allows efficient communications between designers/specifiers and suppliers related to color requirements and/or capabilities.

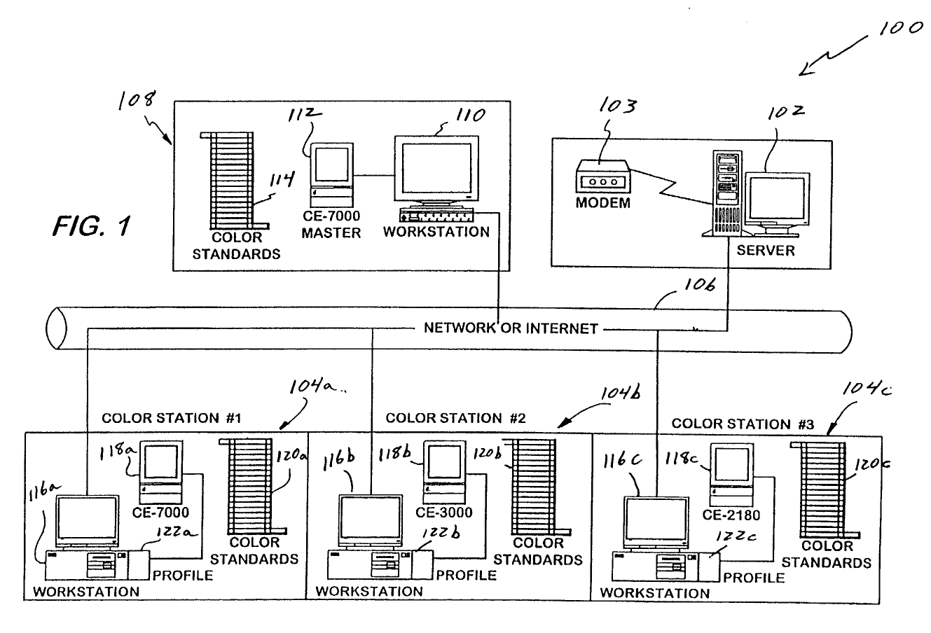

With reference to FIG. 1, an exemplary diagrammatic representation of a color management and communication system 100 is depicted according to the present disclosure. System 100 includes a server 102 that communicates with a plurality of client computer systems or workstations 104a, 104b, 104c via a computer network 106, e.g., a local area network, wide area network and/or the Internet. To facilitate network communications, a modem 103 may be provided in association with server 102, as is known in the art. Alternative network communication systems and modalities are also contemplated, e.g., cable modems and/or connections, ISDN lines, serial line Internet protocol (“SLIP”) connections, point-to-point protocol (“PPP”) connections, and the like.

Server 102 also advantageously communicates via computer network 106 with a master color laboratory 108. Master color laboratory 108 generally includes a computer work station 110, a master color measuring instrument 112, and a master set of color standards 114. As disclosed in U.S. Pat. No. 6,043,894 to Van Aken et al., the contents of which are hereby incorporated by reference, master color laboratory 108 initially calibrates its master color measuring instrument 112, utilizing master color standards 114, and thereafter measures working sets of color standards to determine deviations of each set from master color standards 114.

The measured sets are then advantageously sent to remote color stations 104a, 104b, 104c. Remote color stations 104a, 104b, 104c include client computer work stations 116a, 116b, 116c, color measuring instruments 118a, 118b, 118c, and working sets of color standards 120a, 120b, 120c, respectively. The remote color stations 104a, 104b, 104c measure the working sets of color standards on color measuring instruments 118a, 118b, 118c and transmit the color measurement data over computer network 106 to master color lab 108. Utilizing the transmitted information and prior reference measurements, master color lab 108 generates a color instrument profile 122a, 122b, 122c that is transmitted to remote color instruments 104a, 104b, 104c via computer network 106, such profiles 122a, 122b, 122c providing corrections to be applied to subsequent measurements made by remote color instruments 104a, 104b, 104c.

Of note, the instrument profiles are applied to remeasurements of the working sets of color standards and transmitted to master color lab 108, which analyzes such measurements to determine whether the individual color measuring instruments are within preset specifications for permissible deviation(s). If the remeasurements fall within applicable preset specifications, the remote color laboratory is advised that this instrument is performing satisfactorily, whereas if master color lab 108 determines that deviation of the corrected color measurements received from a remote color lab exceed acceptable amounts of deviation, it revokes the performance certification of the color measuring instrument and requires a repeat of the process to generate a new instrument profile until such time as the instrument generates corrected results within the appropriate specification.

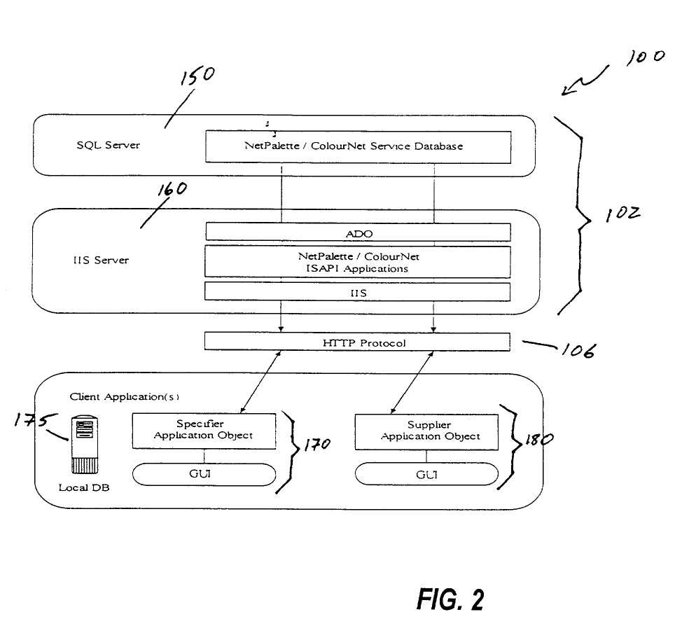

Turning to the schematic depiction of FIG. 2, an exemplary representation of certain aspects of the data transmissions and/or communications associated with color management and communication system 100 is provided. As shown in FIG. 2, server 102 includes a SQL server 150 and an IIS server 160 that cooperate to communicate with client computer work stations 116a, 116b, 116c via computer network 106. IIS server 160 generally utilizes Active X data objects (“ADO”), and Internet server application program interface (“ISAPI”) and an appropriate transfer protocol, e.g., HTTP protocol, to transfer data/information to, and receive data/information from, computer network 106.

As shown schematically in FIG. 2, at least two client applications are contemplated according to the method/system of the present disclosure: specifier/designer client applications) 170 and supplier client application(s) 180. Each of specifier/designer client application(s) 170 and supplier client application(s) 180 communicate via computer network 106 using HTTP protocol. A graphical user interface (“GUI”) is associated with each client application 170, 180 to facilitate user interaction therewith. A local database 175 is also typically associated with each client application 170, 180 within appropriate storage hardware, e.g., RAM, hard drive storage, disk and tape drive storage, network attached storage, and combinations thereof.

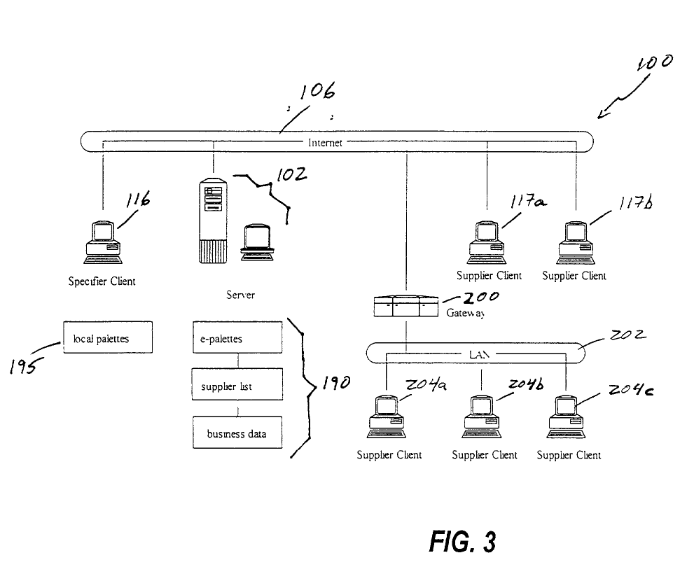

Turning to FIG. 3, a further schematic depiction of further aspects of color management and communication system 100 is provided. As schematically shown in FIG. 3, a specifier may advantageously utilize the disclosed method and system to communicate desired color palette(s) to a predetermined list of suppliers using computer network 106, e.g., the Internet, and the suppliers may access such desired color palette(s) via computer network 106 and respond to the specifier as to capabilities with respect to such desired color palette. Thus, the specifier generally transmits/communicates appropriate information 190 to server 102 via network 106, e.g., electronic representations of desired color palette(s) (“e-palette(s)”), a supplier list, relevant business data (e.g., contact information), and the like. Information 190 is typically stored in a database associated with server 102. Additional color palette information 195 may be stored in a database associated with the specifier's client work station 116.

The specifier's client work station 116 typically includes conventional application program(s) that permit e-palettes to be defined and constructed. An e-palette generally includes sets of spectral data, e.g., reflectance, transmission, over light/over dark, and reflectance/transmission data, as well as associated identifying information, illuminant data, calorimetric attributes, and/or associated image or texture map(s). In preferred embodiments of the present disclosure, sufficient information required to provide a unique visual identity is associated with each e-palette developed by specifiers/designers and transmitted to server 102.

In use, once the specifier/designer has defined/constructed a desired e-palette and communicated such e-palette to server 102, the specifier/designer may advantageously facilitate such e-palette being made available to a predetermined list, group or set of suppliers for review, evaluation and response. Over time, specifiers/designers may develop a preference for certain groups of suppliers in certain circumstances, e.g., certain suppliers may have proven to be most effective in creating colors for use on certain substrates, for responding to urgent requests, to developing colors having certain characteristics, etc. Thus, a specifier/designer may not desire that the same list, group or set of suppliers be solicited in connection with each e-palette transmitted to server 102 according to the present disclosure.

According to preferred embodiments of the present disclosure, a specifier/designer associates a predetermined list, group or set of suppliers with an e-palette at specifier client work station 116, prior to transmitting the e-palette to server 102. In addition, the specifier/designer may optionally associate additional information with an e-palette prior to transmission to server 102, e.g., conditions under which color submissions are to be submitted, timeframes for response, cost constraints, etc. The ability to post e-palettes to server 102 (and/or modify posted e-palettes) on behalf of a specifier/designer is generally controlled by conventional electronic sign-in procedures that are designed to ensure that access is limited to authorized specifier personnel. Administrative functionalities associated with preferred embodiments of the present disclosure allow users of the system to identify authorized personnel, establish log-in names and passwords, etc., and such administrative information is typically stored in a database associated with server 102.

Upon receipt of an e-palette from authorized personnel associated with a specifier/designer, the e-palette is posted to a database associated with server 102. In preferred embodiments, the database within which e-palettes are stored resides upon or within server 102. In addition, server 102 advantageously includes application software that processes the list, group or set of suppliers associated with the e-palette by the specifier, and automatically notifies each of the suppliers included on such list that a new e-palette has been posted for their review, evaluation and responsive handling.

Generally, it is necessary for suppliers to be participants in the disclosed color management and communication system to receive such automatic notifications from server 102. Thus, the disclosed system/method may be advantageously deployed through the supplier community on a subscription and/or licensing basis.

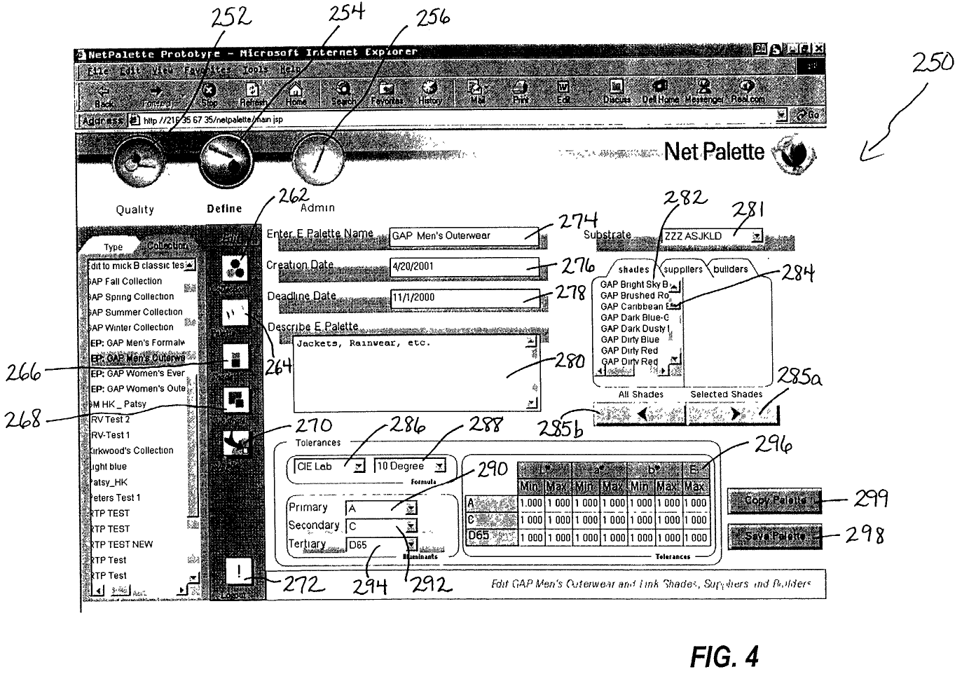

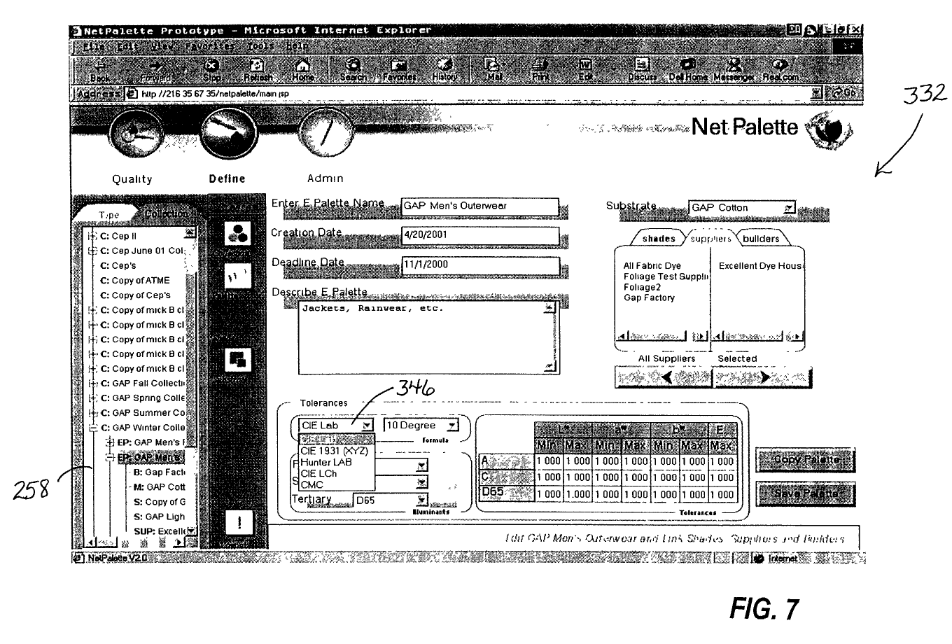

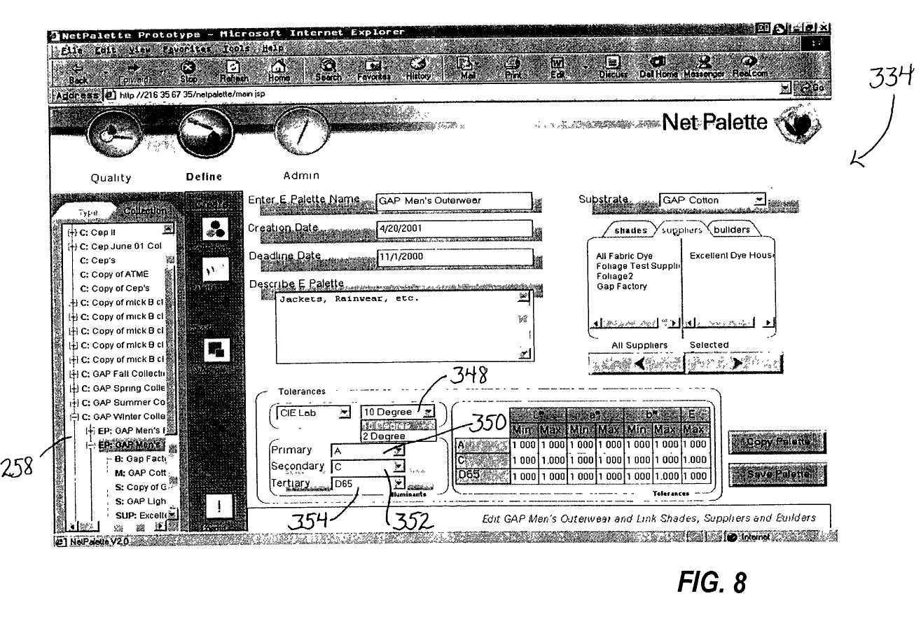

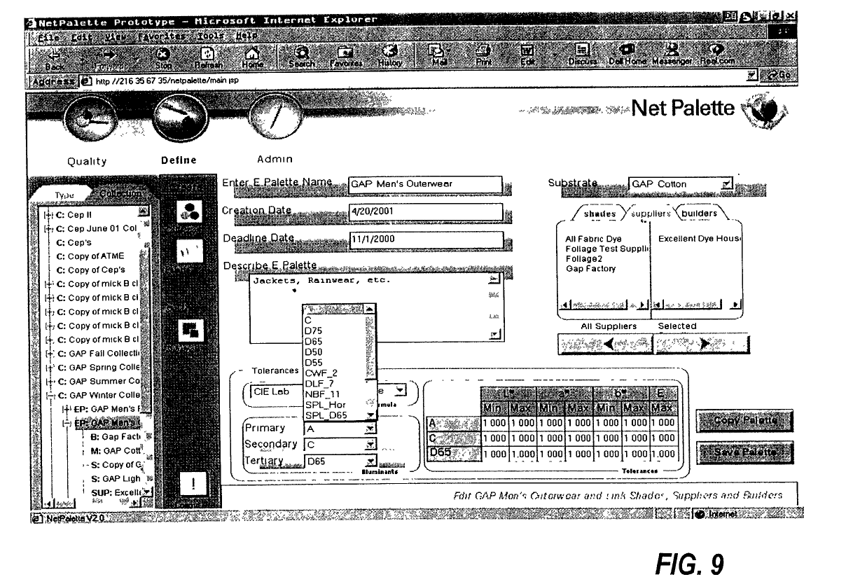

With reference to FIGS. 4-17, a series of exemplary screen shots are provided that illustrate advantageous aspects of preferred system(s) and method(s) for communicating and managing transfer(s) of color information and/or associated tolerancing specifications to and among a distributed network of users according to the present disclosure. The disclosed screen shots are merely illustrative of exemplary system(s)/method(s) according to the present disclosure, and are not to be limiting thereof. Alternative screen layouts, screen sequences and data input/retrieval systems and methodologies are contemplated according to the present disclosure. Accordingly, the present disclosure is not to be limited to the exemplary embodiment(s) disclosed herein.

With more specific reference to FIGS. 4-10, a series of exemplary screen views for use by a designer/specifier in establishing an e-palette are provided. Each of these screens is generally accessed and information/data input to and retrieved from such screens using conventional browser technology. With particular reference to FIG. 4, exemplary screen 250 includes a plurality of links that may be used by a designer/specifier in connection with advantageous functionalities associated with the present disclosure. Of note, three primary links are provided in the upper left region of screen 250, namely a “Quality” link 252, “Define” link 254, and “Admin” link 256.

With initial reference to Admin link 256, users that access administrative functionalities associated with preferred embodiments of the present disclosure are generally able to define and/or modify certain operational/administrative aspects of the disclosed system and method. For example, Admin link 256 generally allows users to establish appropriate access controls, e.g., by way of conventional name/password validations. General levels of user access may be established, as is known in the art, to limit and/or define the range of functions that may be employed by specific users. Other administrative functions generally associated with Admin link 256 include an ability to define and/or modify listings associated with the disclosed system and method, e.g., listings of suppliers, groupings of suppliers (e.g., by substrate specialty, response time, etc.), contact information for suppliers, parameters associated with color definition, and the like. Indeed, it is contemplated that each data field described and/or depicted in connection with the screens of FIGS. 4-13 may be susceptible to administrative control and/or modification via Admin link 256.

Exemplary screen 250 of FIG. 4 is accessed according to a preferred embodiment of the present disclosure by way of Define link 254. The left side of screen 250 includes a listing field 258 of, inter alia., e-palette families or groupings that have been stored on a database associated with the disclosed system and method. A scroll bar 260 permits a user to view all e-palette collections stored on the associated database. To the right of scroll bar 260 on exemplary screen 250 are a series of links associated with the editing of an e-palette, namely Collection link 262, Palette link 264, Shade link 266, Substrate link 268 and Supplier link 270. As shown in FIG. 4, the user has selected Shade link 266 and is permitted to select/edit the shades to be associated with the indicated e-palette. By selecting the other noted links (i.e., Collection link 262, Palette link 264, Substrate link 268 or Supplier link 270), the user may select/edit other aspects of the indicated e-palette. A Logout link 272 is also provided to permit the user to discontinue his/her activities with respect to the noted e-palette.

With further reference to FIG. 4, a series of data fields are depicted to the right of the vertical line of links previously referenced. The top-most data field 274 displays the name of the e-palette grouping or collection that is under review by the designer/specifier. In the depicted exemplary embodiment, the user has selected the “GAP Men's Outerwear” e-palette collection from listing field 258. The remaining data fields reflect data/information previously associated with the GAP Men's Outerwear e-palette or input by the user during his/her current interaction with screen 250. Thus, the database associated with the disclosed system and method stores current data/information associated with these respective data fields, and such data/information may be overwritten by users at subsequent points in time.

The “Creation Date” data field 276 and “Deadline Date” data field 278 reflect relevant dates associated with the noted GAP Men's Outerwear e-palette, namely the date on which the e-palette was first created (Apr. 20, 2001) and the deadline date for completion/sourcing of the e-palette (Nov. 1, 2000 (sic)). A general description of the e-palette is noted in the “Describe E Palette” data field 280, reflecting the general nature of the goods to be treated by the subject e-palette. These four data fields provide general identification information with respect to e-palettes entered into the database associated with the disclosed system and method. The remaining data fields depicted on exemplary screen 250 are generally associated with defining color/shade/measurement aspects of the e-palette.

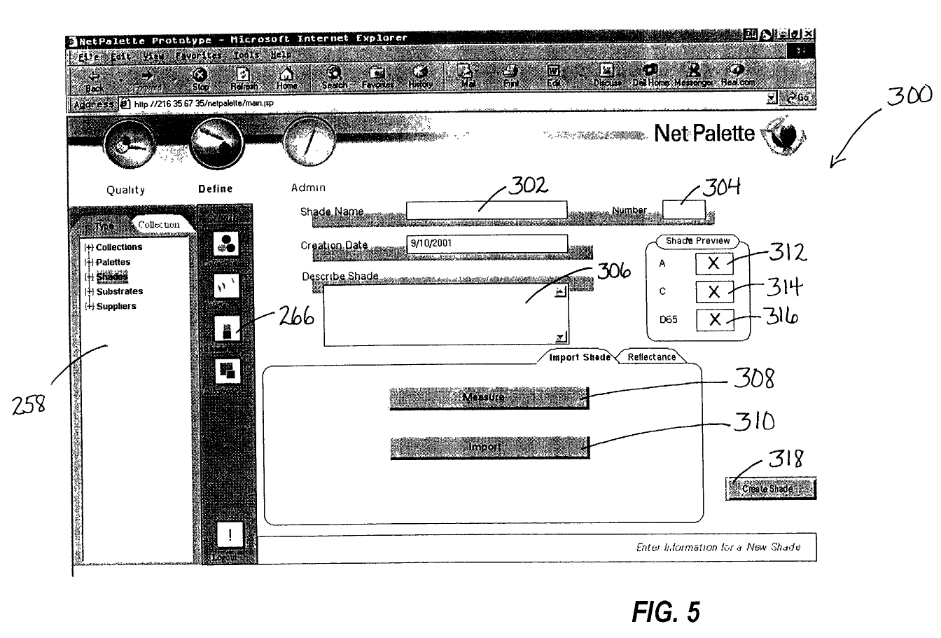

More particularly, “Substrate” pull down window 281 permits a designer/specifier to select a substrate to be included within the noted e-palette, i.e., the GAP Men's Outerwear e-palette. A plurality of substrates are generally included within an e-palette, each of which defines an individual data set within the associated database and appears as a separate “record” within the nesting of the GAP Men's Outerwear e-palette collection (see listing field 258 in FIG. 5). “Shades” menu 282 allows a designer/specifier to select shades to be associated with the GAP Men's Outerwear e-palette. Clicking on individual shades set forth on Shades menu 282 generally causes the selection to appear to the right of the associated scroll bar 284 and become associated with the noted e-palette. Of note, alternative means for selecting and de-selecting Shades for association with the noted e-palette may be provided/employed according to the present disclosure, e.g., selection/de-selection arrows 285a, 285b.

In the lower region of exemplary screen 250, data fields for further defining measurement/tolerancing parameters and characteristics of the noted e-palette are displayed. In particular, drop down menus 286, 288 allow the designer/specifier to provide/select formula-related information, drop down-menus 290, 292, 294 allow the designer/specifier to provide/select illuminant-related information, and data table 296 allows the designer/specifier to provide/select tolerancing information, e.g., based on the L*a*b* color space. Upon completion of the creation/editing process associated with exemplary screen 250, the designer/specifier may preserve the e-palette on the associated database by selecting the “Save Palette” button 298. In addition, a user may utilize the e-palette data/information associated with the noted GAP Men's Outerwear as a starting point for an alternative e-palette, e.g., by selecting the “Copy Palette” button 299.

Turning to FIG. 5, a further exemplary screen 300 for use by a designer/specifier in establishing an e-palette is provided. Screen 300 is particularly designed to facilitate creation/modification of a “shade” associated with an e-palette. In the pictured embodiment of FIG. 5, screen 300 is being used for initial creation of a shade, as evidenced by the fact that the data fields are empty (with the exception of the default creation date). Screen 300 may be accessed by selecting Shade link 266 or by clicking on the Shades file designation in listing field 258. As shown on exemplary screen 300, a preferred shade creation/modification screen according to the present disclosure includes data fields for providing a “Shade Name” (data field 302), Shade “Number” (data field 304) and Shade Description (data field 306). Shade names and numbers are generally specified/established by the designer.

In addition, exemplary screen 300 permits a designer/specifier to measure (button 308) and/or import (button 310) a desired shade based on ancillary measurement equipment associated with the disclosed system and method, e.g., using conventional spectrophotometric technology. Preferably, the operation of the associated equipment is standardized, e.g., utilizing the NetProfiler® system described hereinabove. Screen 300 also provides shade preview functionality in data fields 312, 314, 316 based on conventional primary, secondary and tertiary illuminant values. The designer/specifier may utilize the “Create Shade” button 318 to input a completed/satisfactory shade to the associated database.

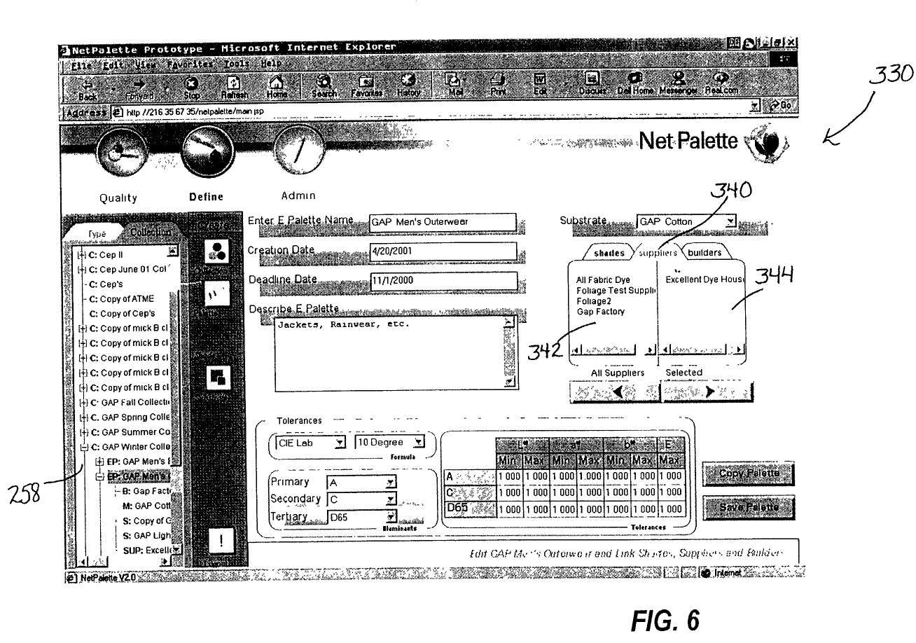

Turning to FIGS. 6-8, additional exemplary screens 330, 332, 334 for use by a designer/specifier in establishing an e-palette are provided. Each of these screens is associated with the creation/modification of an illustrative GAP Men's Outerwear e-palette which may be accessed from listing field 258 from the associated database. With particular reference to FIG. 6, a designer/specifier is provided with an opportunity to select the suppliers to be included in a network to receive the GAP Men's Outerwear e-palette according to the present disclosure. The Suppliers block 340 includes a left column 342 that includes suppliers for potential inclusion in the network, whereas the right column 344 includes only those suppliers that have been selected by the designer/specifier for inclusion therein. Population of the list of suppliers that initially appears in left column 342 is generally accomplished within administrative functionality associated with preferred systems and methods of the present disclosure.

According to preferred embodiments of the present disclosure, different subpopulations may be automatically displayed within left column 342 based on characteristics and/or parameters associated with individual e-palettes, e.g., the nature of the substrate, the time period between the creation date and the deadline date (i.e., timeliness), and/or tolerancing criteria. Thus, designers and specifiers utilizing preferred embodiments of the disclosed system/method are able to determine those suppliers that they want to participate in supplying palettes for use on thread versus cotton versus polyester, etc. Designers/specifiers may also predefine suppliers to be included in rush requisitions, as contrasted with “normal turnaround.” Alternative bases and/or scenarios for establishing supplier subpopulation will be apparent to persons skilled in the art based on the exemplary bases/scenarios described herein, and such alternatives are deemed to be within the spirit and scope of the present disclosure.

Of note, a further set of recipients of e-palettes established according to the present disclosure may be defined by the designer/specifier, namely entities referred to as “builders.” Builders represent entities that will be involved in some aspect of end product manufacture, but that are not directly involved in the color work flow process. For example, “builders” may ultimately be called upon to cut or sew garments that utilize raw materials to be colored based on the color work flow of the present disclosure. To facilitate timely preparation and planning, preferred embodiments of the disclosed system and method permit designers/specifiers to select appropriate builders to be included in the exchange of information disclosed herein. As with the supplier subpopulations described hereinabove, subpopulations of builders may be developed, e.g., within the administrative functionality of the disclosed system/method, for use in communicating with appropriate subsets of builders, e.g., based on the nature of the goods to be manufactured.

Turning to FIGS. 5 and 6, additional screens for use by designers/specifiers in formulating e-palettes according to the present disclosure are provided. Screens 332, 334 illustrate pull-down menus 346, 348, respectively, which may be used by designers/specifiers to create and/or modify tolerancing parameters associated with e-palettes of interest. Similar pull-down menus 350, 352, 354 are provided with respect to illuminant parameters to be associated with such e-palettes. Additional parameters may be incorporated into screens used by designers/specifiers in defining e-palettes according to the present disclosure, as will be apparent to persons skilled in the art.

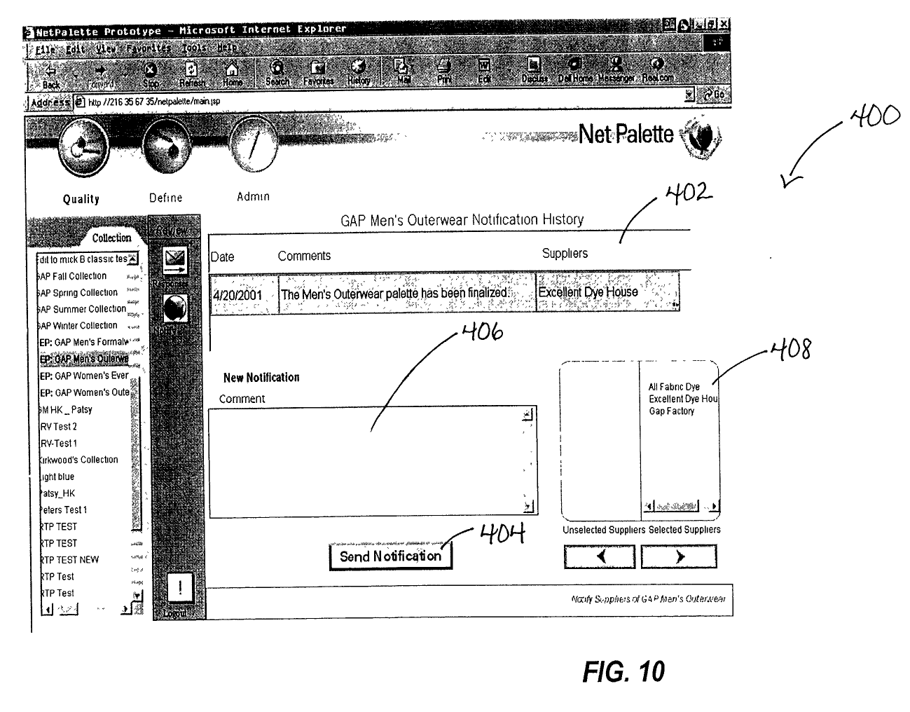

With reference to FIG. 10, exemplary screen 400 may be used by a designer/specifier to transmit an e-palette to a desired network of suppliers (and builders). Screen 400 includes a status block 402 that reflects relevant information concerning the e-palette of interest, e.g., date, comments and suppliers involved in reviewing/responding to e-palette. In the illustrative embodiment of FIG. 10, status block 402 reflects the fact that “The Men's Outwear palette has been finalized” and that “Excellent Dye House” is the selected supplier for such palette (as of Apr. 20, 2001). Screen 400 also permits the designer/specifier to send notifications related to the subject e-palette by clicking Send Notification button 404, e.g., if a new supplier is desired or if a supplier has yet to be Selected. Comments block 406 permits the designer/specifier to communicate narrative information to recipient suppliers, e.g., “rush job” or the like. Recipient block 408 lists the predetermined network of suppliers to receive notification of the e-palette, i.e., based on the selections previously implemented with respect to the e-palette by the designer/specifier.

When a designer/specifier clicks Send Notification button 404, the recipient suppliers are automatically notified that a designer/specifier has made available an e-palette for review and response. In preferred embodiments of the present disclosure, notifications are transmitted to the network of suppliers by electronic mail. Additionally, suppliers that log on to the disclosed system will receive notification of a newly available e-palette. Alternative means of notification are also contemplated, e.g., automatic facsimile, pager communication, telephone communication and the like. Suppliers that are not included in the predetermined supplier network will not be notified of its existence, nor will such omitted suppliers be able to access such e-palette from the system according to the present disclosure.

Thus, as illustrated by exemplary screens 250, 300, 330, 332, 334, 400, a designer/specifier is provided with an ability to define e-palettes of interest to his/her business objectives and transmit such e-palettes to supplier(s), as desired. E-palettes are generally identified by the designer/specifier, e.g., by name and/or number, and are associated with deadline dates for completion. Key parameters that define individual e-palettes are defined using such browser-based system, and stored to a database associated with the disclosed system. E-palette groupings or collections are generally defined by a series of individual e-palettes. The present system also advantageously permits designers/specifiers to select or define supplier groupings or subgroupings to be included in reviewing and responding to proposed e-palettes. A pre-population of suppliers, with appropriate contact information, is generally created by such specifiers/designers, e.g., within the administrative functionality of the disclosed system and method. Individual suppliers may be particularly suited to reviewing and responding to particular types of e-palettes, e.g., e-palettes for use on specific classes of substrates, and the system may advantageously and automatically display a subpopulation of suppliers based on such criteria for use in selecting/defining a supplier network in connection with a specific e-palette. Similarly, builders that will ultimately be involved in processing/fabricating products associated with the e-palette may be included in the communicative process according to the present disclosure. Of note, multiple individuals within an organization may participate in different aspects of the specifier/designer side of the disclosed system and process, e.g., based on particular areas of expertise or responsibility, such group of individuals collectively being referred to as the “specifier/designer” for purposes of the present disclosure.

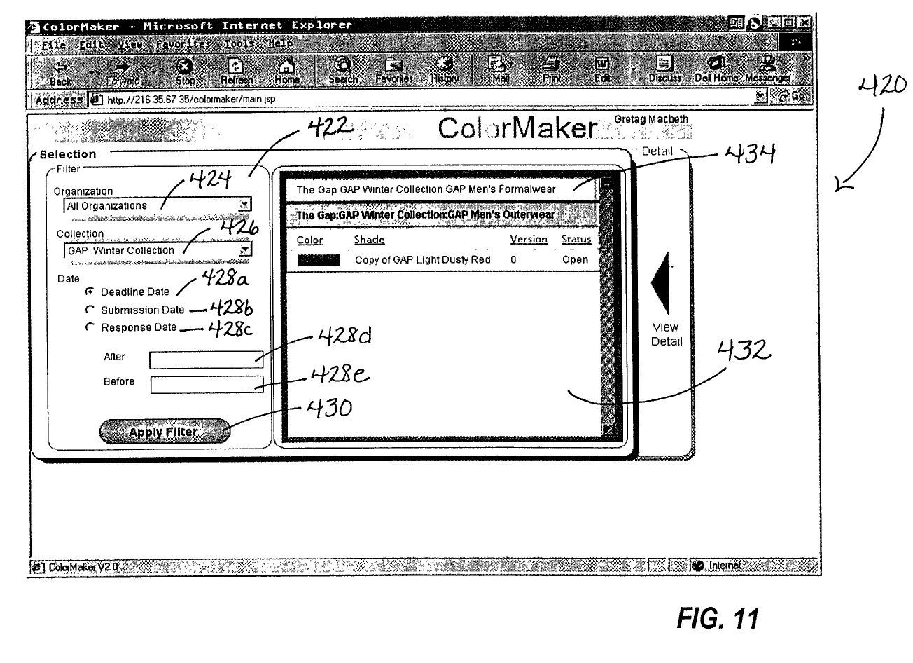

Turning to the supplier-side of the disclosed system and method, FIGS. 11-14 illustrate exemplary screens utilized by supplier(s) involved in a color management process according to the present disclosure. As noted previously, designers/specifiers involved in creating e-palettes select specific suppliers to receive such e-palettes, i.e., establish a predetermined supplier network for receipt of and response to e-palette transmissions across the disclosed system. Thus, the exemplary screens depicted in FIGS. 10-14 reflect screens to be viewed by suppliers included in such predetermined supplier network. In order to view such screens, supplier personnel are generally required to sign in, e.g., using an appropriate user name and password, thereby restricting access and utilization to approved individuals and suppliers. The supplier may be alerted to sign in by a variety of notification mechanisms, e.g., electronic mail, facsimile transmission, telephone message, or the like.

With particular reference to FIG. 11, exemplary screen 420 illustrates a screen view that may be accessed by suppliers according to a preferred embodiment of the present disclosure. Screen 420 includes filtration functionality that permits the supplier to focus on palette submissions using desired criteria, e.g., submissions from particular designers/specifiers, submissions having particular temporal characteristics, and the like. Thus, exemplary screen 420 includes filtration block 422 that includes an organization filter block 424, a palette collection filter block 426, and a series of date filtration fields 428a, 428b, 428c, 428d, 428e. By selecting from among the organizations listed in the drop-down menu (not pictured) associated with organization filter block 424, a supplier may limit the e-palettes displayed on screen 420 to those designers/specifiers of immediate interest. Similarly, specific collections may be selected via collection filter block 426. Date ranges of interest (e.g., with respect to deadline date, submission date or response date) may be established using the “After” and/or “Before” filtration fields 428d, 428e. Once the Apply Filter button 430 is clicked, the disclosed system only displays those e-palettes that satisfy the applicable filtration criteria in e-palette display block 432. As shown in FIG. 420, no filtration criteria are being utilized by the supplier, i.e., “all organizations” have been selected in organization block 424 (generally a default setting).

With further reference to e-palette display block 432, the supplier is provided with relevant information as to an e-palette that has been submitted for the supplier's review and response. In the illustrated embodiment, the e-palette for which a detailed view is provided is the “GAP Winter Collection: GAP Men's Outerwear” e-palette. A second e-palette (GAP Men's Formalwear) is available for detailed review by clicking on an associated horizontal link 434 or by selecting this alternative e-palette from collection filter block 426. Based on the information shown in display block 432 for the illustrative GAP Men's Outerwear e-palette, the supplier is apprised of the color and the name assigned to the indicated shade by the designer/specifier (“Light Dusty Red”). The indicated shade is one shade associated with this particular e-palette. Additional shades associated with this e-palette may be forthcoming, or may have been provided to a separate network of suppliers by the designer/specifier.

Exemplary screen 420 also provides the supplier with important status information with respect to the depicted e-palette. For example, the “Version” information in display block reflects whether a previous submission to the designer/specifier has been made by the supplier relative to this shade. In the exemplary embodiment depicted in FIG. 11, the Light Dusty Red shade is at version “0”, i.e., no previous submissions have been made by the supplier with respect thereto. Each time a submission is made by a supplier to a designer/specifier with respect to an e-palette shade, the “version” indicia automatically iterates by one, thereby tracking the efforts expended by the supplier with respect to such e-palette.

The “Status” indicia set forth in display block 432 reflects whether the designer/specifier has received and accepted/approved a supplier submission with respect to the subject e-palette. An “open” status, as depicted on exemplary screen 420, indicates that the designer/specifier has not accepted/approved a submission and that, therefore, the supplier may be yet be selected/approved as the color maker for the indicated e-palette upon receipt of a satisfactory submission. The Status indicia is automatically updated for all suppliers included in the supplier network for a given e-palette upon selection/approval of a supplier submission by the designer/specifier, thereby minimizing inefficiencies and wasted efforts on the parts of suppliers.

A supplier may view more detailed information with respect to an e-palette by clicking on the e-palette of interest. Thus, exemplary screen 440 depicts detailed information that may be viewed by a supplier within the predetermined supplier network for the illustrative Light Dusty Red shade. The shade name, number (“66”) and shade description are provided by the designer/specifier. Of note, the formula, illuminant and tolerance information set forth in the lower portion of screen 440 corresponds to the tolerance-related information input by the designer/specifier (see, e.g., screen 250 of FIG. 4). The supplier may view additional information related to the collection, the e-palette and/or the substrate by selecting view buttons 442, 444, 446, respectively. Additionally, shade preview block 448 visually displays color-related information associated with the e-palette, which may be printed by the supplier using a color printer.

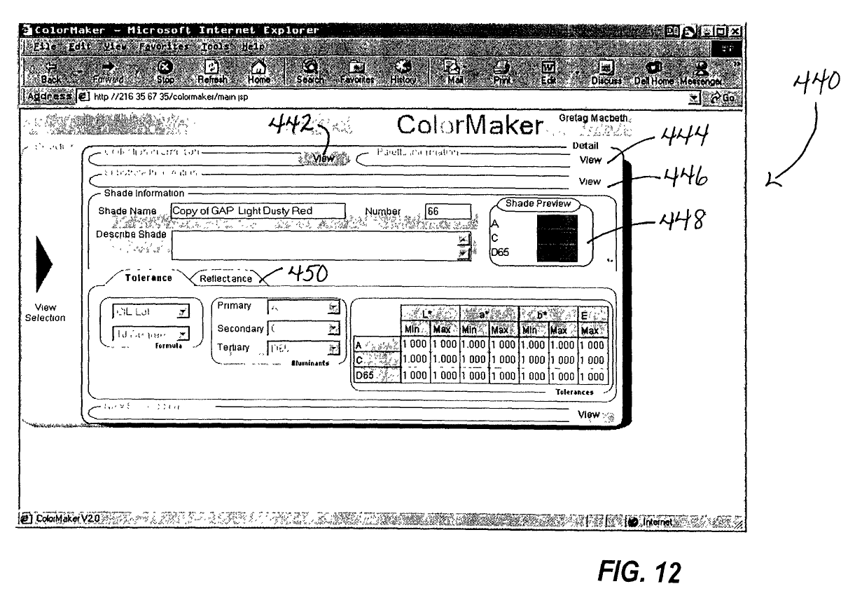

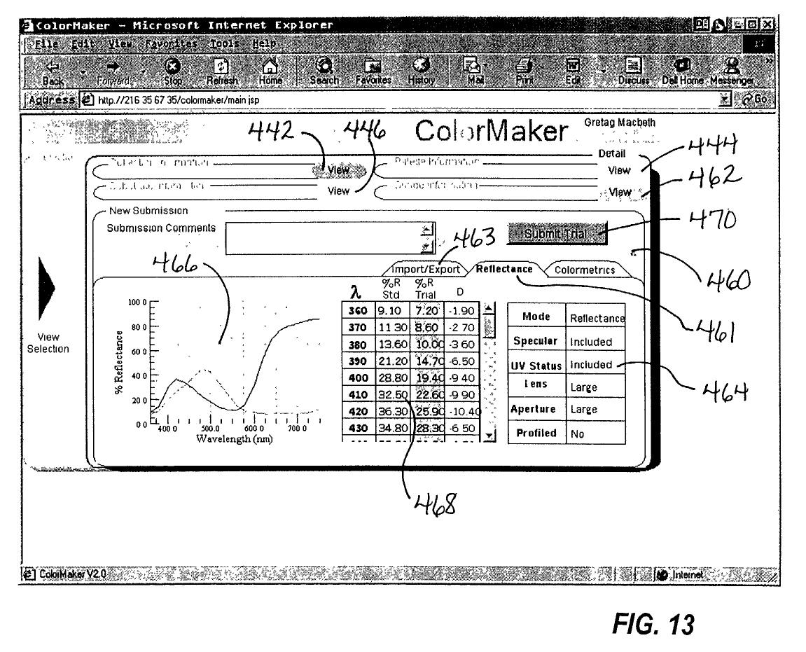

The supplier may view the actual spectral data measured into the disclosed system by the designer/specifier by clicking reflectance tab 450. Indeed, the spectral data associated with the subject e-palette may be advantageously exported into the supplier's local computer system to facilitate formulation efforts. Such spectral data may be accessed by supplier personnel, as necessary, e.g., utilizing an intranet, LAN or WAN from decentralized geographic locations. With reference to FIG. 13, reflectance information associated with the subject e-palette is set forth in the lower region 461 of exemplary screen 460. As with screen 440 of FIG. 12, view buttons 442, 444, 446 provide the supplier with access to more detailed information concerning the e-palette. An additional view button 462 provides the supplier with access to the shade information shown on screen 440 of FIG. 12, i.e., view button 462 provides a link to exemplary screen 440 for viewing of shade-related information.

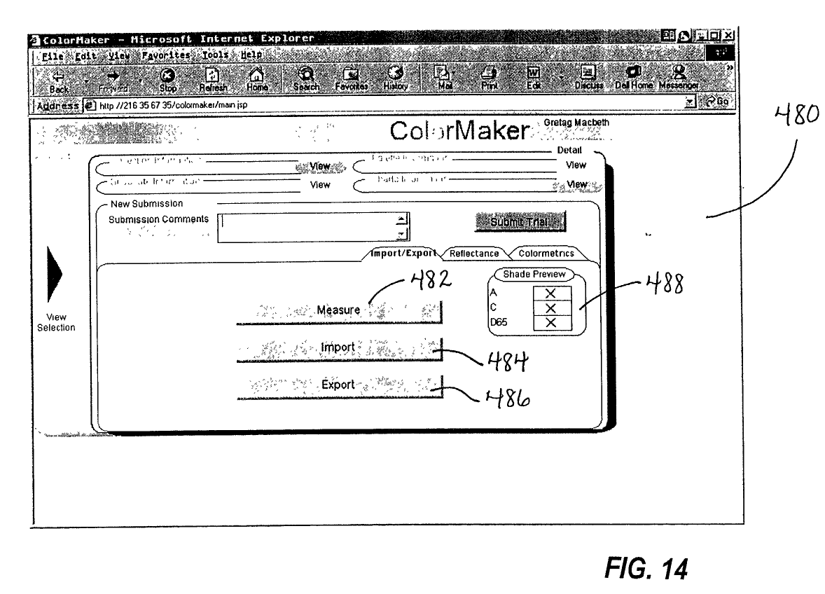

The Import/Export tab 463 permits a supplier to measure/import/export data, as shown by exemplary screen 480 of FIG. 14. From screen 480, a supplier can elect to: (i) import data (button 482) related to an e-palette from a designer/specifier, e.g., download such data to a local hard drive or server, (ii) export data (button 484) related to a potential e-palette submission to a remote server or network location, e.g., a storage medium or network attached storage (NAS) location, and/or (iii) measure (button 486) a potential e-palette submission so as to evaluate, inter alia., its reflectance characteristics as compared to the target values established by a designer/specifier. Thus, by clicking on button 482, a supplier is generally brought to a screen akin to exemplary screen 460 of FIG. 13, with data presentations as described herein. Moreover, screen 480 generally includes a shade preview block 488 that allows immediate viewing of a potential submission (and optional printing to an associated color printer).

With further reference to FIG. 13, the reflectance information set forth in lower region 461 includes information concerning the equipment settings and operation used in measuring a potential supplier submission, as shown in table 464. The mode, specular setting (e.g., reflected at 45°), UV status (e.g., 350-400 nm), lens and aperture parameters are set by the ancillary instrumentation employed by the supplier in measuring the properties of a potential e-palette submission. The “profiled” setting indicates whether operation of the ancillary instrument has been standardized or profiled using the NetProfiler® system described hereinabove. Thus, based on the “no” entry in the illustrated table, it is apparent that the ancillary equipment is not being profiled by the NetProfiler® system.

In an exemplary embodiment of the present disclosure, the NetProfiler® system is advantageously utilized to standardize the equipment of a manufacturer that may have many manufacturing plants located around the world, each plant capable of manufacturing a product or raw material, e.g., plastic, for commercial use. Spectrophotometric equipment is generally located at each manufacturing facility, and the color measurements for each such piece of spectrophotometric equipment (regardless of manufacturer/model) is established with the NetProfiler™ system associated with the disclosed system/method.

Turning to the remaining information set forth in lower region 461, data is provided that allows the supplier to evaluate the relative conformance of a potential e-palette submission relative to the standards set by the designer/specifier. A graphical representation 466 charts percent reflectance versus wavelength for the desired e-palette and for the supplier's potential submission. Additionally, a tabular presentation 468 of percent reflectance for a range of wavelengths is provided for the e-palette standard and for the supplier's potential submission, together with a measure of deviation. Based on the supplier's review of the data set forth in lower region 461, he/she can determine whether the potential submission is sufficiently similar to the desired e-palette to warrant submission to the designer/specifier. Submission is accomplished by clicking the “Submit Trial” button 470.

Once the supplier elects to submit a trial to the designer/specifier, all measured data with respect to such e-palette submission is transferred to a central server/database associated with the disclosed system/method. Up until the point when a supplier chooses to affirmatively submit a trial, all work performed toward developing an appropriate e-palette submission is unknown to the central server/database, i.e., such local activities are not stored to the central server/database. In this way, a supplier is free to work toward meeting the e-palette requirements of a designer/specifier without risk of lost credibility due to premature subpar/unacceptable submissions being made. From the standpoint of the designer/specifier, the local development activities of the various suppliers safeguards him/her from being inundated with undesirable, wasteful and presumably unsatisfactory e-palette submissions. Moreover, the capacity of the central server/database is preserved by restricting e-palette storage to those e-palette submissions that are to be passed along/reviewed by the designer/specifier.

Upon submission of a trial by a supplier, the designer/specifier is typically notified of the availability of such submission on the central server/database associated with the disclosed system/method. Such notification may take a variety of forms and may include multiple communicative techniques. Thus, for example, the designer/specifier may be notified by electronic mail, facsimile transmission, pager, telephone contact, and combinations thereof. Alternatively, personnel associated with the designer/specifier may already be logged onto the disclosed system/method, and may be apprised of the availability of the supplier's submission through conventional browser-based notification techniques, e.g., an update notification posting. Of note, other suppliers included in the predetermined supplier network are not apprised of a competing supplier's submission, unless and until such submission is accepted/approved by the designer/specifier.

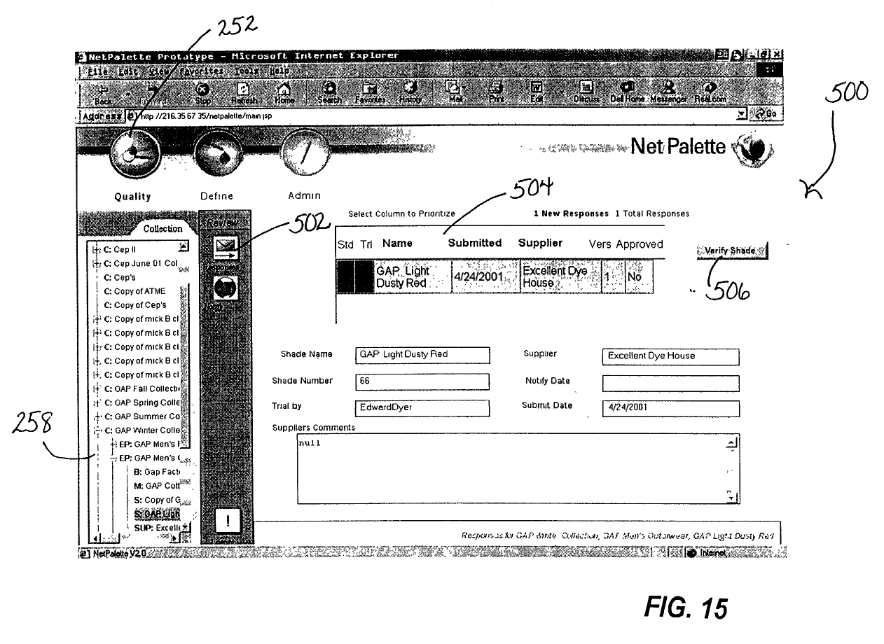

With reference to FIG. 15, a designer/specifier may access a supplier submission from the server/database on which it is stored, e.g., from exemplary screen 500 which is generally accessed by clicking on Quality link 252. To review supplier submission(s) associated with a particular e-palette, e.g., the GAP Light Dusty Red shade, the designer/specifier generally highlights the desired shade in listing field 258 and selects the “Responses” button 502 adjacent thereto. The disclosed system displays the status of any/all responses associated with the selected e-palette shade, e.g., GAP Light Dusty Red. As shown in table 504 of FIG. 15, a single submission from a supplier, namely the “Excellent Dye House,” was received on Apr. 24, 2001, according to the illustrated embodiment. As also noted in table 504, the April 24th submission is the first submission version and it has not yet been approved by the designer/specifier.

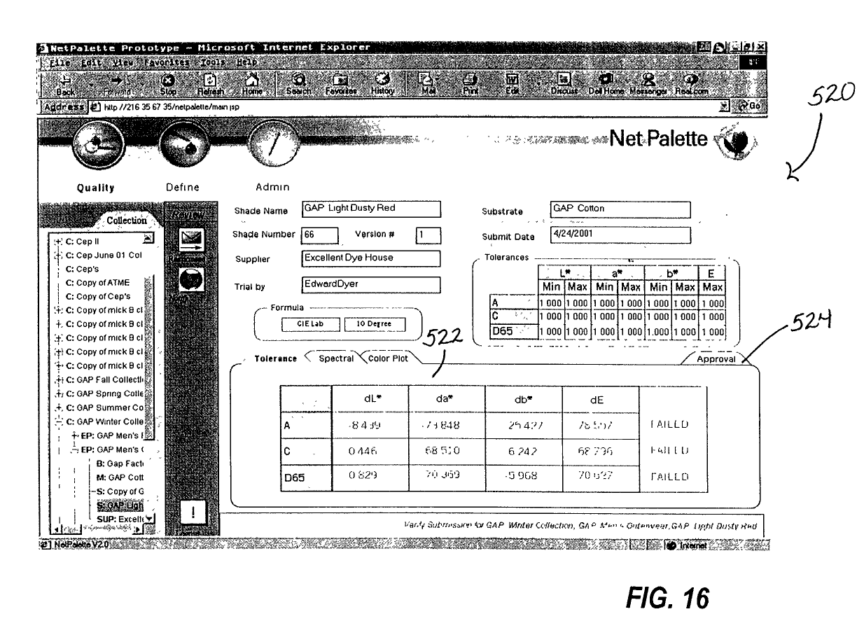

To determine the acceptability of the supplier's submission, the designer/specifier generally selects the “Verify Shade” button 506 to assess the performance of the e-palette submission relative to the established criteria. The Verify Shade button 506 retrieves the information/data stored on the central server/database associated with the disclosed system, and displays such information/data for inspection and evaluation by the designer/specifier. As shown on screen 520 of FIG. 16, all relevant tolerance (table 522), spectral and color plot data is available for inspection and evaluation. According to preferred embodiments of the present disclosure, the disclosed system automatically calculates whether the supplier submission satisfies the criteria established by the designer/specifier in defining the e-palette, and displays a pass/failed determination as to each such criteria. Thus, as illustrated in table 522, the supplier submission failed with respect to each of the noted criteria.

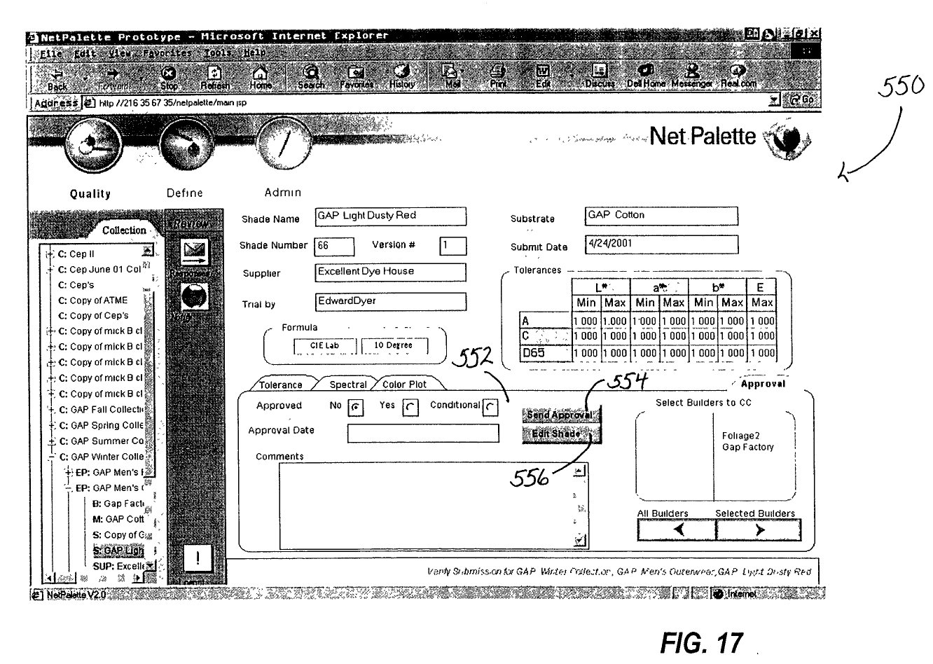

Based on its review of a supplier submission, the designer/specifier generally communicates his/her conclusions with respect to such e-palette submission. Of note, a designer/specifier may elect to approve/accept a supplier's submission even if one or more pre-established criteria are not satisfied, e.g., if the criteria are determined to be overly aggressive, time pressures require acceptance, etc. To communicate with the supplier, the designer/specifier may click the Approval tab 524 and access exemplary screen 550 shown in FIG. 17. In the lower region 552 of FIG. 17, communication fields are provided for use by the designer/specifier in formulating a reply to the supplier.

According to preferred embodiments of the present disclosure, a designer/specifier has three general responses: Approved, Not Approved or Conditionally Approved. The initial two responses are relatively straightforward, and may be transmitted to the supplier with comments, as may be desired by the designer/specifier. In addition, one or more builders may be included in the transmission so as to ensure that such entities are kept apprised of progress on the e-palette requisition process. Conditional approval may be provided to the supplier, e.g., if the submission doesn't meet the tolerance criteria but is to be nonetheless accepted. The Send Approval button 554 is clicked when the designer/specifier is satisfied with the response, and the supplier (and any designated builders) is notified of the communication in the way(s) described above, e.g., e-mail, facsimile, etc. If the supplier's submission is accepted, the status of the e-palette submission is updated for all suppliers in the supplier network. If the submission is not approved, and the supplier chooses to make a subsequent submission, the disclosed system automatically iterates the supplier's version status so as to ensure that the parties have access to the iterative status of the color management process.

Based on its review of the supplier submission, the designer/specifier may determine that it is appropriate to edit one or more parameters associated with the shade. By clicking the Edit Shade button 556, the designer/specifier is returned to the screen(s) associated with defining/editing a palette, e.g., exemplary screen 250 of FIG. 4. Any edits to the shade may be communicated to the same, or a modified, group of suppliers for review and response. The disclosed system advantageously monitors/tracks changes to e-palettes and typically reflects the fact that changes/edits have been made in subsequent transmissions to suppliers.

The disclosed system generally includes advantageous reporting capabilities and/or functionalities. Thus, for example, a series of standard report formats may be advantageously incorporated as part of a report module. The reports may be divided into three general categories: detailed reports, summary reports and supplier reports. Each of these report categories is described in turn.

Detailed reports generally provide information on three major types of data included within the server/database associated with the present disclosure, namely collections, e-palettes and shades. Thus, a detailed collection report generally provides a collection's current status within the color management workflow. Critical information tracked and displayed generally includes: (i) the number of open shades, (ii) the number of shades approved, and (iii) the number of shades for which submissions are overdue. A detailed e-palette report typically provides information on the status of an e-palette, as it relates to its parent collection, within the color workflow. Critical information tracked and displayed generally includes: (i) the approval status of the shades within the palette, (ii) the names of approved suppliers, and (iii) the number of submissions against a shade. A detailed shade report typically provides information on a shade's submissions history, within the context of its parent palette. Critical information tracked and displayed generally includes: (i) a list of suppliers making submissions, (ii) submission approval status, and (iii) comments from the suppliers.

Summary reports provide critical date information with regard to the status of collections and palettes within the color management workflow. A collections summary report typically displays a list of all collections for which associated palettes remain incomplete. The report may include a list of incomplete palettes, associated critical dates, open shade counts, and indicators of days past deadline (by palette). A palette summary report generally displays a list of all palettes for which associated shades remain incomplete. Exemplary reports include a list of incomplete shades, associated deadlines, and counts of days past deadline. A supplier summary report typically displays the status of all palettes assigned to a particular supplier. Exemplary reports include a list of all palettes (and their associated shade lists), numbers of submissions, numbers of approvals, past due indicators, and approval performance. A supplier overdue submission report generally displays a list of suppliers from whom submissions are overdue. The report typically includes a list of suppliers and their associated list of overdue palettes and shades.

Preferred report modules according to the present disclosure may be implemented as Web based applications. Remote users interact with the disclosed system using a standard Web browser. The majority of the logic that determines the user interface and the business logic advantageously resides on the central server associated with the disclosed system. The look, feel, and content of the user interface are determined by the dynamic HTML that resides on the server side and specifics of how the screen will be laid out are logically separated from the details of what data will be displayed on the user's screen. The set of rules that determine screen content are generally incorporated as part of the systems business logic modules.

Presentation logic modules control layout and display. In addition to containing the HTML and bit map images that will determine the visual layout and appearance, the presentation modules also address the dynamic HTML (for client side execution) and internationalization. The business logic modules provide an interface between the presentation logic modules and the underlying database, e.g., Oracle database. Links and server side scripts contained in the presentation logic modules invoke the business logic modules. The server side scripts generally utilize Java servlets to assist with the business logic. The business logic may be implemented with a combination of Java Server Pages (JSP's), Java servlets, and Enterprise Java Beans (EJB's). The presentation logic may be implemented as HTML, with JPEG bit maps for images. The dynamic HTML support is generally realized through a combination of client side Applets and JavaScript.

Each of the defined report types may have a query construct, e.g., as follows:

For detailed collection, the query may by collection;

For the detailed e-palette, the query may be by palette within a collection. Palettes displayed for selection are only those associated with the previously selected collection.

For detailed shade, query may be by shade within a palette within a collection. Shades displayed for selection are only those associated to a previously selected palette. Palettes displayed for selection are only those associated to a previously selected collection.

For the collections summary, multiple query constructs are contemplated: (i) query by collection; (ii) query by deadline date range; (iii) query by collections with “n” open palettes; and (iv) query by collections that are “n” days overdue.

The palettes summary may also have multiple query constructs: (i) query by collection; (ii) query by deadline date range; (iii) query by collections with “n” open shades; and (iv) query by palettes that are “n” days overdue.

The supplier summary may also have multiple query constructs: (i) query accredited suppliers; (ii) query unaccredited suppliers; and (iii) query suppliers with overdue submissions.

The supplier overdue submissions report generally has two query constructs: (i) query by collection deadline date range; and (ii) query by palette deadline date range.

Having thus described preferred embodiments and exemplary uses/applications of the present disclosure, it is to be understood that the specifically disclosed applications are merely illustrative of the scope of the present disclosure. Various changes may be made in the function and arrangement of aspects hereof; equivalent means may be substituted for those described and/or illustrated; and certain features may be used independently from others without departing from the spirit and scope of the invention as defined in the claims that follow.

1. A system for facilitating communications between a specifier and one or more suppliers, said system comprising:
a) a server in communication with a plurality of client workstations,
b) a storage medium associated with said server for receiving and storing parameters communicated from a specifier workstation related to an e-palette,
c) a processor associated with said server and in communication with said storage medium and with programming that operates with said processor:
i) to monitor communications to said server from said plurality of client workstations related to said e-palette; and
ii) to automatically communicate the existence of a communication related to said e-palette from one of said plurality of client workstations to said specifier workstation.

2. A system according to claim 1, wherein said programming further operates with said processor to automatically communicate to said plurality of client workstations the existence of a communication from said specifier workstation related to said e-palette.

3. A system according to claim 1, wherein said server communicates with said plurality of client workstations across a computer network.

4. A system according to claim 3, wherein said computer network is selected from a group consisting of a local area network, a wide area network, an intranet, the Internet and a combination thereof.

5. A system according to claim 1, wherein said storage medium includes a database that is configured to receive and store said parameters related to said e-palette.

6. A system according to claim 5, wherein said parameters related to said e-palette are selected from a group consisting of colorimetric data, spectral data, reflectance data, transmission data, illuminant data, image map, texture map and combinations thereof.

7. A system according to claim 5, wherein said parameters related to said e-palette include information unrelated to color selected from a group consisting of a predetermined set of suppliers, supplier submission condition, supplier response timeframe, cost data, and combinations thereof.

8. A system according to claim 1, further comprising a color measurement device in communication with at least one of said plurality of client workstations, said color measurement device being configured to measure at least one of said plurality of parameters related to said e-palette.

9. A system according to claim 8, wherein said at least one of said plurality of client workstations is in communication with profiling programming that profiles operative performance of said color measurement device.

10. A system according to claim 1, wherein said programming further operates with said processor to support administrative functionality aaccessible by a specifier from said specifier workstation.

11. A system according to claim 10, wherein said administrative functionality provides said specifier with an ability to define predetermined sets of suppliers for subsequent communication in connection with an e-palette defined by said specifier.

12. A system according to claim 1, wherein said programming further operates with said processor to support reporting functionality accessible by a specifier from said specifier workstation.

13. A system according to claim 12, wherein said reporting functionality provides said specifier with an ability to access reports associated with e-palette communications selected from a group consisting of detailed reports, summary reports and supplier reports.

14. A system according to claim 1, wherein said communication between said server and said plurality of client workstations utilizes CxF language protocols.

15. A method for facilitating communications between a specifier and one or more suppliers, said method comprising:
a) receiving an e-palette across a computer network at a server, said e-palette originating from a specifier workstation and including parameters related to said e-palette, said parameters including a predetermined set of suppliers associated with said e-palette by said specifier;
b) automatically communicating to said predetermined set of suppliers the existence of said e-palette at said server; and
c) permitting remote access to said e-palette by said predetermined set of suppliers at said server.

16. A method according to claim 15, wherein said parameters further include color information selected from a group consisting of calorimetric data, spectral data, reflectance data, transmission data, illuminant data, image map, texture map and combinations thereof, and information unrelated to color selected from a group consisting of supplier submission condition, supplier response timeframe, cost data, and combinations thereof.

17. A method according to claim 15, wherein said method further comprises:
a) receiving at said server a submission from at least one of said predetermined set of suppliers in response to said e-palette; and
b) automatically communicating to said specifier the existence of said submission by said at least one of said predetermined set of suppliers at said server.

18. A method according to claim 17, that further comprises facilitating iterative communications between said specifier and said at least one of said predetermined set of suppliers related to said e-palette.

19. A method according to claim 18, further comprising:
a) storing information related to said iterative communications in a database associated with said server; and
b) providing reporting functionality related to said iterative communications between said specifier and said at least one of said predetermined set of suppliers.

20. A method according to claim 15, that further comprises restricting access to information stored at said server to pre-approved entitities.

21. A method according to claim 15, that further comprises automatically validating operation of color measuring equipment involved in measuring color attributes associated with an e-palette received at said server.

22. A system for facilitating communications between a specifier and one or more suppliers, said system comprising:
a) a server in communication with a plurality of client workstations and adapted to receive e-palette information;
b) a processor associated with said server that includes programming for limiting access to and controlling integrity of said e-palette information; and
c) a storage medium associated with said server for receiving and storing said e-palette information,
wherein said e-palette information includes parameters communicated to said server by a specifier and at least one responsive e-palette submission communicated to said server by a supplier.

23. A system according to claim 22, wherein said e-palette information includes color information selected from a group consisting of calorimetric data, spectral data, reflectance data, transmission data, illuminant data, image map, texture map and combinations thereof, and information unrelated to color selected from a group consisting of a predetermined set of suppliers, supplier submission condition, supplier response timeframe, cost data, and combinations thereof.

24. A system according to claim 22, wherein said at least one responsive e-palette submission is accessible only to said specifier.
